(19) United States
(12) Patent Application Publication
(10) Pub. No.: US 2016/0191192 A1
(43) Pub. Date: Jun. 30, 2016

(54) ASSEMBLY OF STANDARD DWDM DEVICES FOR USE ON FREE-SPACE MULTIPORT DWDM DEVICES

(71) Applicant: XUEFENG YUE, San Jose, CA (US)

(72) Inventor: XUEFENG YUE, San Jose, CA (US)

(21) Appl. No.: 14/852,540

(22) Filed: Sep. 12, 2015

Related U.S. Application Data
(60) Provisional application No. 62/098,989, filed on Dec. 31, 2014.

(51) Int. Cl. H04J 14/02; H04B 10/11

(52) U.S. Cl. CPC H04J 14/0215; H04B 10/11

(57) ABSTRACT

The invention teaches the design and assembly configurations for a free space DWDM device. Particularly, when using the free space DWDM devices for channel spacing less than 200 GHz, a small angle of incidence requires a longer optical path and adjustments must be made by folding the optical path or using double layers of optical components such as collimators to shorten the device and obtain the compact dimensions of the DWDM device. The design of the compact optical devices are implemented and assembled with various positioning and mounting methods for the newly designed optical base member, collimators, and filters to obtain the desired compact free space DWDM devices

### REFERENCE TO RELATED APPLICATION

The present application claims priority to the provisional Appl. Ser. No. 62/098,989 filed on Dec. 31, 2014, the entire content of which is hereby incorporated by reference.

### FIELD OF THE INVENTION

The present invention generally relates to the field of fiber optic engineering. More particularly, the invention relates to methods of improving optical multiplexing and demultplexing such as add/drop devices in fiber optic development including new optical layouts and manufacturing processes.

### BACKGROUND OF THE INVENTION

For increasing the capacity of transmission for fiber optic communications and networking, a technology called wavelength-division multiplexing (WDM) is used for multiplexing a number of optical carrier signals onto a single optical fiber. With the use of different wavelengths of laser light, this technique is used to transfer optical signals through a single optical link. During multiplexing, an optical device can add and drop one or more wavelength channels to the existing multi-wavelength WDM signal.

Multiplexers and demultiplexers are commonly used to add and drop one or more wavelength channels to the existing multi-wavelengths channel. This technique is more cost effective than using more fibers to carry signals. In early design methods and traditional methods, only one color light, such as 1550 nanometer light, was used on a single strand of fiber to carry information. However the internet boom of the late nineteen nineties encouraged service providers to increase the capacity in their network, especially in the most economical way. The three-port WDM device was invented and became the commonly used base device while also providing the better example of how the technology operates. Three-port WDM devices can be made with thin film filters (TFFs) with optical coatings on the surface. A multiplexing device combines many different colored lights to be applied to a single strand of fiber. A demultiplexing device can separate combined colored light from a single fiber into separate individual fibers and if used in the reverse direction, the demuliplexing device can combine different colored lights from individual fibers into a single fiber. The TFF's are designed to transmit certain wavelengths of colored light while reflecting other wavelengths of colored light. Additionally three-port WDM with thin film filter devices can be cascaded together to obtain higher channel counts such as four, eight, sixteen, and thirty two channel multiports as well.

Furthermore, Dense Wavelength Division Multiplexing (DWDM) filters are designed for a certain incident angle. The common Angle of Incidence (AOI) is 1.8 degrees. This allows the filter to be in line with the center wavelength, bandwidth, and desired angle of incidence. The thin film filters are fine-shifted by adjusting the incident angle to the ITU grid, wherein the ITU grid for channel spacing can be 200 GHz grade, 100 GHz, 50 GHz or smaller.

When focusing on a specific range of wavelengths, dense wavelength division multiplexing is used to refer to a narrower wavelength band within 1550 nanometers. This wavelength allows the abilities of the erbium doped fiber amplifiers (EDFAs) to be more effective. Between the 1525-1610 nanometer wavelengths, the EDFA's capabilities are leveraged by amplifying any signal in this operating range. As long as the pump energy is available, the EDFA's can amplify as many optical signals as can be multiplexed into its amplification band. This is cost effective and efficient for multiplexing in the specified ranges of wavelengths mentioned above. To separate wavelengths of light, dense division multiplexing (DWDM) devices are commonly used. In a DWDM device, oftentimes the spacing of the wavelengths are positioned in a frequency grid having exactly 100 gigahertz (GHz) of spacing. The main grid is placed inside the optical fiber amplifier bandwidth and can be extended to wider bandwidths. The DWDM thin film filter chips can be designed for larger AOI with angles more than the standard 1.8 degrees, however they are expensive and not widely available.

As described in U.S. Publication No. 2010/0329678 issued to Wang and Wu on Dec. 30, 2010, the assembly configuration consists of mounting collimators to a substrate, while the substrate is connected to prisms and TFF's for separating light into different wavelengths in a WDM device. The layout of this optical assembly has design limitations for overall compactness. The angle of incidence of a light beam to the filters determines the spacing between two ports in a free space arrangement. In an instance where filters and collimators are coupled together and placed side by side with a certain distance from center to center, the optical path varies depending on the incident angle and the larger the incident angle, the shorter the optical path length. The designed angles of CWDM filters are generally 8, 10, and 13.5 degrees, which enables a short optical path and thus a compact device.

However in a DWDM optical device, the filters available are generally with 1.8 degree of angle of incidence. Having larger AOI does not make economic sense, even if it would be possible to do so technically. In this case, the configuration of optical components in the U.S. Publication No. 2010/0329678 issued to Wang and Wu would not guarantee a compact optical device.

What is needed is an improved assembly arrangement for the optical components with a manufacturing process in transferring optical signals through a single optical link such as an optical fiber, particularly when designing free space compact DWDM devices using the small angle of incidence filter. The design and assembly configurations for optical devices in a DWDM device including a particular group of 50, 100, and 200 GHz channel spacing ITU grids with the improvement provided by the invention will be described below.

### SUMMARY OF THE INVENTION

In order to increase the capacity of a single strand of fiber in an optical assembly, a multiplexing and demultiplexing device can be used to combine and separate the wavelengths of light. DWDM devices are used for all wavelengths including the S, C, and L band wavelengths. Included in the optical assembly, are 50, 100 and 200 GHz thin film filter chips (depending on desired spacing), collimators for adjusting the light beams, and prisms for reflecting and refracting the wavelengths of light. When light beams incident to the TFF's certain wavelengths are refracted, other wavelengths are reflected. For TFF based free-space DWDM device, enough space has to be provided in order to align the DWDM filters and collimators, whose diameters are generally in the range of 1.2 to 1.8 mm. This is to say that a round trip of light through the optical components shall have a walk-off distance of 1.2 to 1.8 mm. The walk-off distance is determined by the angle of incidence to the filters. In case of WDM with larger channel spacing (>200 GHz) as provided in the U.S. Publication No. 2010/0329678, the designed AOI can be as large as 13.5 degree. Such CWDM filters are widely available.

This allows for a shortened optical path for a desired compact device. However, by using the DWDM devices for channel spacing less than 200 GHz, the small AOI will require a longer optical path and adjustments must be made by folding the optical path or using double layers of collimators to obtain the compact dimensions of the optical device. The novel design of the compact optical devices are implemented and assembled with various positioning and mounting methods for the collimators and filters in order to obtain the desired compact free space DWDM devices. Objects, features, and advantages of the present invention will become more apparent with regard to the following detailed description of the embodiments, claims, and attached drawings.

### BRIEF DESCRIPTION OF THE DRAWINGS

FIG. 1 is a side view of a 3-port DWDM device containing input port, Gradient Index lens, thin film filter, input port, upgrade port, and drop port; the side view is used to further explain the function of multiplexing and demultiplexing for separating and combining different wavelengths of light into a single strand of optical fiber.

FIG. 2 is an illustration of a multi-channel Dense Wavelength Division Mulitplexing device by cascading more than two 3-port devices.

FIG. 3 is an illustration of the glass base member and prism for a single layer type of configuration in order to present a free-space DWDM device.

FIG. 4 is an illustration of a standard WDM filter with a relatively large angle of incidence for free-space WDM devices; the distance L from the filter to the reflection surface of mirror has a minimum requirement to allow filters and collimators to be aligned in the same layer; the larger the incident angle, the smaller of optical path that could be achieved.

FIG. 5 is an illustration of an example of subassembly to realize compact DWDM devices with a long optical path.

FIG. 6 is a side view illustration of the DWDM device as shown in FIG. 5; the dashed lines are representing the light beam passing through the optical components including the addition of a glass plate prism.

FIG. 7 is a bottom view of FIGS. 5 and 6 with arrow indicators showing the path of the light beam through the optical components in a DWDM device.

FIG. 8 is a side view of another configuration of collimators aligned in two vertical layers assembled on top of each other in an assembly; the hashed lines indicate the path of the light beam as it passes through the collimators, thin film filters, and prism.

FIG. 9 is an isometric view as shown in FIG. 8 with the collimators aligned in two layers assembled on top of each other in an assembly.

FIG. 10 is an isometric view of a different configuration of the glass base member and prisms for a two sided type of configuration that a free-space DWDM device can be constructed.

FIG. 11 is a side view of FIG. 10 with the hashed lines indicating the path of the light beams as they pass through the collimator, filter, and three prisms.

FIG. 12 is a front view of two collimators aligned side by side; the triangle glass mounting method is indicated in this illustration to attach the input and output collimators.

FIG. 13 is an illustration of double layered collimators; the triangular glass block assembly method is presented to shows that collimators are held from the side when enough space exists between them.

FIG. 14 is an illustration similar to FIG. 13 where the collimators are in a tightly aligned structure with the small glass triangle block bridging both layers of collimators together.

### DETAILED DESCRIPTION OF THE DRAWINGS

While the present invention may be embodied in different, forms, designs, or configurations, for the purpose of presenting an understanding of the principles of the invention, references will be made to the embodiments illustrated in the diagrams and drawings. Specific language will be used to describe the embodiments. Nevertheless it is intended to show that no limitation or restriction of the scope of the invention is thereby intended. Any alterations and further implementations of the principles of this invention as described herein are as they would normally occur to one skilled in the art to which the invention relates.

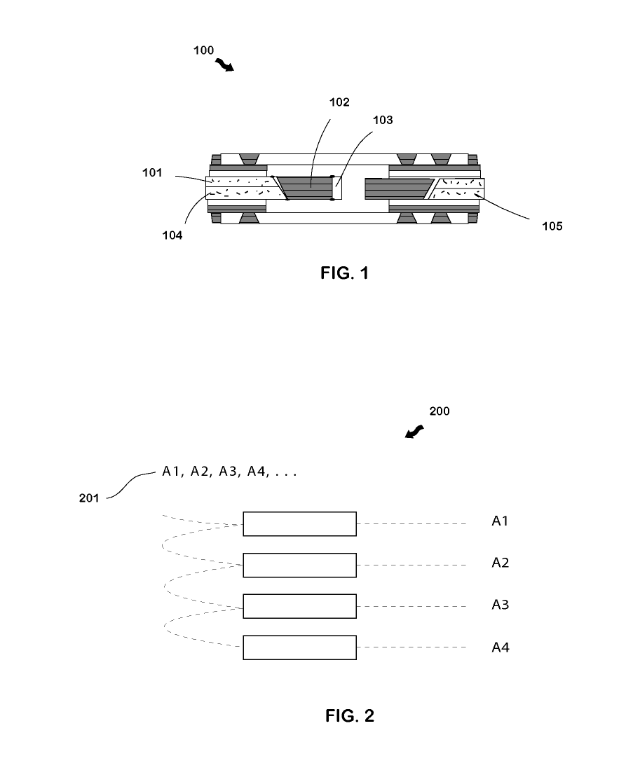

FIG. 1 is a side view of a 3-port Dense Wavelength Division Multiplexing device 100. The side view displays the positioning of the components along with the functionality of the device. Input port 101 uses a combined colored light from a single fiber and separates light into individual fibers. Different wavelengths of colored light enter the input port and pass through a gradient index GRIN lens 102. The GRIN lens 102 collimates the light so it will not diverge into a large uncontrolled beam while a thin film filter 103 is placed behind the gradient index lens 102 for filtering the wavelengths of the colored light. The reflected light travels to a different fiber in the upgrade port 104. Certain wavelengths will pass through the thin film filter 103 depending on the designed TFF used in the DWDM. The colored light entering the Input port 101 and incident on the TFF 102 with a small incident angle, is reflected back and travels toward the upgrade port 104. For example, if a single strand of fiber in the Input port 101 has 3 wavelengths of colored light, the TFF selected can pass the wavelength of light into a single strand of fiber in the Drop port 105. The two other remaining wavelengths will be reflected into the port 104 and placed in separate individual fibers. As described above, the reflected light of the TFF 103 will offset the wavelengths in the vertical direction which allows the reflected light to enter separate strands of fiber in the Upgrade port 104. While this operation is called demultiplexing, multiplexing works in a similar way, except single strands of fibers carrying one wavelength of light, can be combined into a single strand of fiber carrying several different wavelengths.

FIG. 2 is an illustration of a multi-channel Dense Wavelength Division Mulitplexing device 200 by cascading multiple 3-port devices. Thin film filter based DWDM devices can be cascaded together to obtain higher channel counts such as 4, 8, 16, and 32 channels. Yet, coupling the DWDM devices multiple times has its disadvantages. More space is used due to the fiber routing and a higher loss accrues between the free space and the single strands of fiber. The illustration shows the function of a multiplexing device where separate wavelengths are combined into a single strand of fiber. In this illustration for the benefit of clarity, four wavelengths of colored light indicated by A1, A2, A3, and A4 are shown to enter an input port and go through the filtering process to obtain a desired signal on a fiber optic link 201.

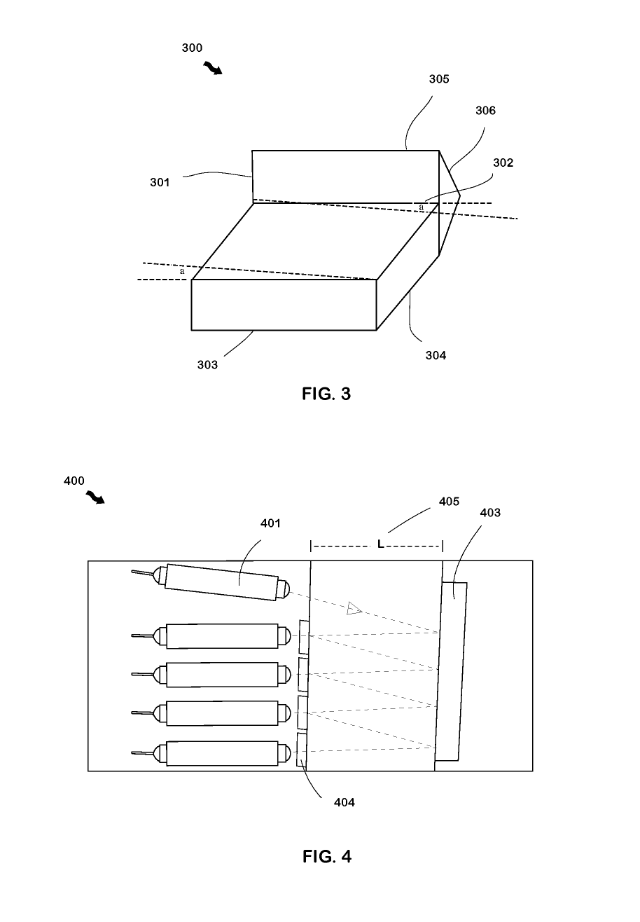

FIG. 3 is an illustration for a specific type of configuration of prisms for a free space DWDM device. In this particular layout, the base member 304 is a transparent glass plate. The back vertical side 303 has a high reflectivity coating. The horizontal surface the base member 304 is cut with a specific angle 302. Thus, the shape of the base member 304 consists of a parallelogram. This particular configuration with the angled the base member 304 allows for a free space DWDM device to be possible in a compact device. As light enters the right angled prism 305, the hypotenuse surface 301 has an anti-reflection coating surface which allows light to pass through the surface 301 and reflect down from the angled side 306. As light reflects down from right angled prism 305, the base member's 304 back vertical surface 303 allows for light to be reflected with a high reflectivity coated surface. Light can reflect back to the right angle prism 305 and again out of the transparent surface 301. The optical path length is folded by using a glass plate prism member 304 to pass light. In previous configurations of WDM devices, the base member 304 was replaced with a metallic material. The metallic base member 304 was used solely as a surface for assembly of optical components. In this newly designed glass base member 304, the specific angle 302 allows for the required angle of incidence for light to pass through the right angled prism 305 and glass base member 304 and shorten the distance of TFF to the surface 301, which lead to overall reduction of physical dimension. In the following FIGS. 4, 5, and 6, the configuration of the collimators and thin film filters assembled to the glass plate prism and how a free space DWDM device operates with this configuration will be explained in details.

FIG. 4 is an illustration to indicate optical components and the orientation of collimators 401, TFF's 404 and a mirror 403 inside a Wavelength Division Multiplexing device (WMD) 400. This is the basic configuration widely known in the industry that free-space WDM including CWDM and DWDM based on. Collimators 401 are telescope-like devices used to focus the light beams on the strands of fibers. The thin film filters 404 generally have footprints of 1.0 to 1.8 mm. Individual fiber collimators 401 may be used with an array of lenses and fibers to build a free space cascaded compact DWDM devices. To shift a reflected beam a distance of 1.2 to 1.6 mm, the TFF 404 must be at least 3-5 mm from the mirror 403 when the AOI is about 10 degree for CWDM case. However, the filters must be at least 20-25 mm from the mirror 403 as shown with distance L 405 in the illustration for an AOI of 1.8 degree in a DWDM case.

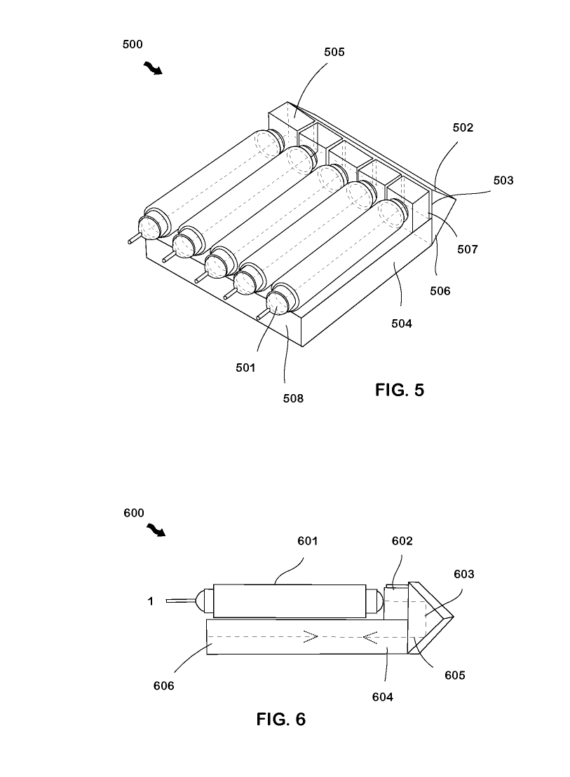

FIG. 5 is an illustration of an array of collimators 501 assembled to a glass plate 504 in a DWDM device. In this illustration, there are five collimators 501 and the first collimator 501 is aligned and parallel to the other four collimators 501. Light from a single collimator 501 passes through a thin film filter 505 and is refracted and incident to the right angle Prism 503 with an incident angle that is the same of glass plate 504 cutting angle. The angle of prism 505 is determined by the glass plate 504 cutting angle as well. The exact relationship is easily calculated by Snell's law for optics. Other collimators 501 are aligned with a thin film filter 505 and to the hypotenuse side of the prism 503. Prism 503 is with anti-reflection front surface 507 and other two surfaces 502 and 506 are polished without any coating. Light with multiple wavelengths is totally reflected and passes into the glass plate 504. Light finally hits the last surface 508 of glass plate 504 where a high-reflectivity coating is applied. The light then goes back and horizontally shifts a certain amount since there is an angle of light to the edge or collimators 501 (the same as cutting angle). One color light pass through the first thin film filter 505 and is collected by the second collimator 501. Light of all other colors is reflected and this process repeats though the collimators 501 until multiple colors have been separated. This completes the demultiplexing operation. Light can be transmitted bidirectionally, such that light from separate fibers follows the reversed optical path and realizes the multiplexing process.

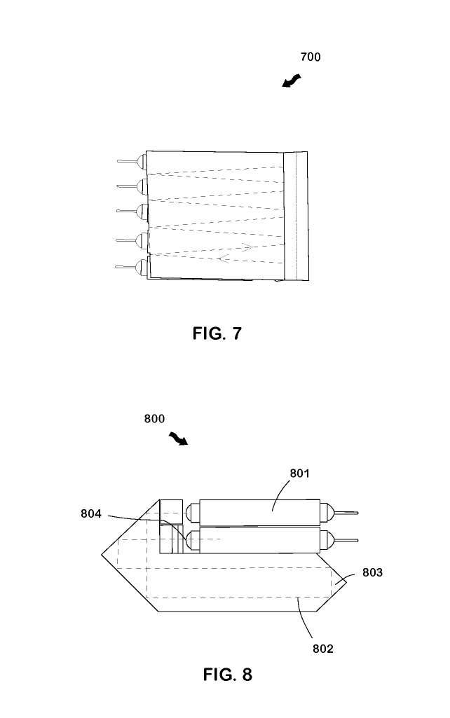

FIG. 6 and FIG. 7 displays a side view and bottom view illustration respectively of FIG. 5 for clarity of indicating the beam path in a free-space DWDM device 600. In the illustration of an array of collimators 601 assembled to a glass plate 604 in a DWDM device 600 from a side view is shown. In this illustration, the first collimator 601 is aligned and parallel to other collimators 601. Light from the first collimator 601 passes through a thin film filter 602 and is refracted and incident to the right angle prism 603 with an incident angle that is the same of glass plate cutting angle. Other collimators 601 are aligned with a thin film filter 602 and to the vertical side of the prism 603. Prism 603 is with anti-reflection front vertical surface while the other two surfaces are polished without any coating as described in FIG. 3. Light with multiple wavelengths is totally reflected and travels into the glass plate 604 as shown by hashed line arrow 605. Light hits the last surface 606 of glass plate 604 where a high-reflectivity coating is applied. The light then goes back and horizontally shifts a certain amount since there is an angle of light to the edge of the collimator 601 which is the same as the cut angle of the glass plate prism. 603 One color of light passes through the first thin film filter 602 and is collected by the second collimator 601. Light of all other colors is then reflected and this process repeats until multiple colors have been separated. This completes the demultiplexing operation and light could also be transmitted bidirectionally. Thus light from separate fibers follows the reversed optical path and realizes the multiplexing process. In FIG. 7 the light beam path is shown in a top view orientation 700 for yet another simplistic view of the light beams passing through the glass plate prism to separate colors and demonstrates the demultiplexing described in FIG. 6.

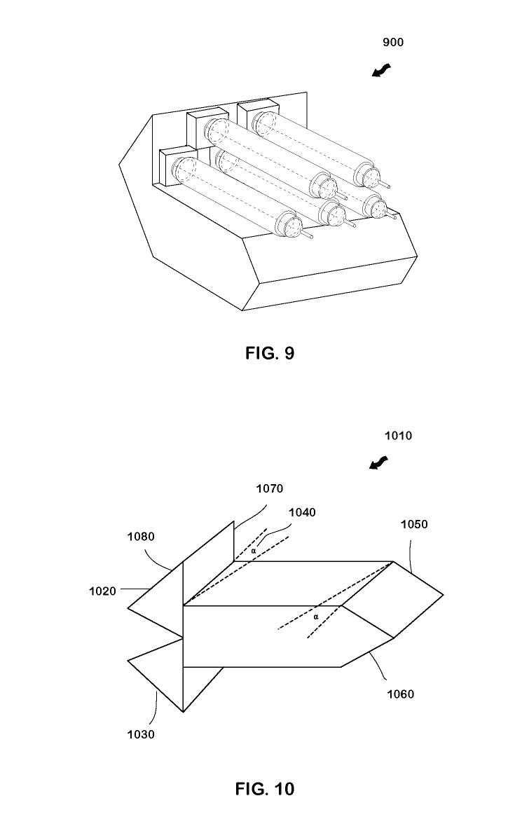

FIG. 8 and FIG. 9 are illustrations of optical components configured inside a DWDM device 800. In FIG. 8, two layers of collimators 801 are stacked one above another for a compact assembly configuration. FIG. 8 indicates with a dashed line 802, the path of the optical beams as light passes through prisms 803 and filters 804, and separates light into different wavelengths. To fit a DWDM in a compact device, the configuration in FIGS. 8 and 9 display a novel invention. The glass plate prism 803 is added to bend light a third time and thus creates a shorter physical length. Collimators 801 and thin film filters 804 can be arranged closer together with the addition of the third glass plate base prism 803 to fit in a compact device. In FIG. 9, there is an isometric view of the 5 collimators arrangement for a simplified viewing and clarity of FIG. 8.

FIG. 10 is an illustration for another specific type of configuration of prisms for a free space DWDM device 1010. In this particular layout, the base member 1060 is a transparent glass plate. The back vertical side 1050 has no reflectivity coating. It is shaped as a right angle prism as opposed to the previous configuration in prior figures where the shape was flat. The horizontal surface of the base member 1060 is cut with a specific angle 1040. Thus, the shape of the base member 1060 consists of a parallelogram. This particular configuration with the base member 1060 allows for a free space DWDM device to be possible in a compact device. As light enters the right angle prism 1020, its hypotenuse side has an anti-reflection coating surface 1070 that allows light to pass through the surface 1070 and reflect down from the angled side 1080. As light reflects down from right angled prism 1020, the base member 1060's back vertical surface 1050 allows for light to be bounced back to hit the lower prism 1030. As light enters the lower prism 1030, the optical components such as the collimators can be configured below the base member 1060 to collect the light. The path length is shortened by using a glass base member 1060 to pass light. As mentioned before, in previous configurations of WDM devices, the glass base member 1060 was replaced with a metallic material. The metallic base member 1060 was used solely as a surface for assembly of optical components. In this newly designed glass base member 1060, the angled cut indicated by alpha 1040 allows for the required angle of incidence necessary for light to pass through the right angled prism and glass plate member to help shorten the optical pass length and allow for a DWDM device.

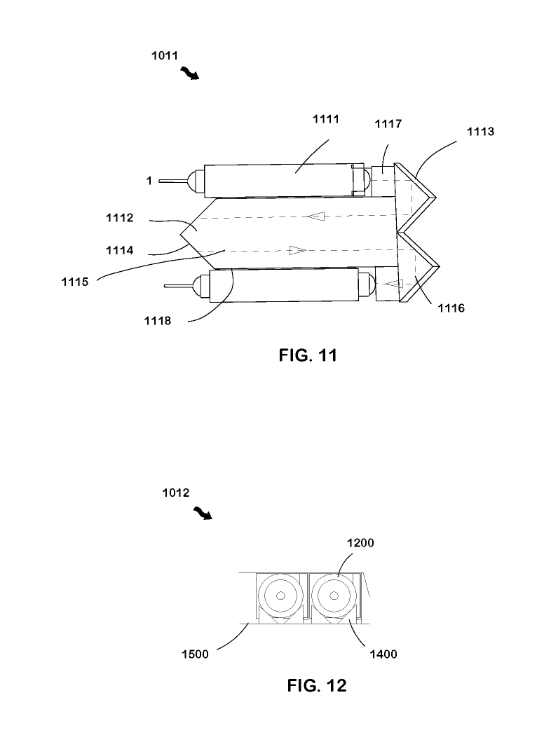

FIG. 11 is an illustration of a double layer structure of an array of collimators 1111 assembled to a glass plate 1112 in a DWDM device 1011. In this illustration, the first collimator 1111 is aligned parallel to other collimators 1111. Light from collimator 1111 passing through a thin film filter 1117 is refracted and incident to the right angled Prism 1113 with an incident angle that is the same of glass plate cutting angle. The angle of prism 1113 is determined by the glass plate cutting angle. The exact relationship is again determined by Snell's law. Other collimators 1111 are aligned with a thin film filter 1117 and to the bottom horizontal side 1118 of the glass plate 1112. The prism 1113 is with anti-reflection front surface and other two surfaces have no coating. Light with multiple wavelengths is totally reflected and goes into the glass plate 1112. Light hits the last surface 1114 of glass plate 1112 where again no coating is applied. As shown in this figure, the back side of glass plate 1112 is shaped as a right angled prism similar to the prism 1113. This allows light to go back and pass through prism 1116 below prism 1113. The collimators 1111 on the top row focus to pass light through the prisms 1113, 1116 and into the bottom row of collimators 1111 indicated by the arrow 1115. Light horizontally shifts a certain amount because there is an angle of light to the edge of collimator 1111 which is the same as the cutting angle of prism 1112. One color light passes through the first thin film filter 1117 and is collected by the second collimator 1111. Light of all other colors is reflected and the process repeats until multiple colors have been separated. This completes the demultiplexing and light can be transmitted bidirectionally such that light from separate fibers follows the reversed optical path and realizes the multiplexing process.

FIG. 12 is an illustration of a front view of two collimators 1200 aligned side by side horizontally. In FIG. 12, the assembly method for the collimators 1200 includes a wedge-mounting configuration .The illustration in shown in FIG. 12 is intended to show that triangular-shaped glass 1400 can be used to attach the input and out collimators 1200 inside a DWDM device. Since the surface of the collimator 1200 is curved it is best to position a flat side of a triangular shaped mounting block 1500 to a horizontal surface of the glass surface while the angled side of the triangular-shaped glass 1400 will allow a secure wedge mounting position for the round collimators 1200. When two triangular-shaped blocks 1400 are cured to a glass surface with angled sides facing each other as shown in FIG. 12, the collimator 1200 can wedge in between the two blocks 1400 for a secure mount. This configuration is one mounting method for including a number of collimator optical devices to form a compact DWDM device. As illustrated in FIG. 12, two collimators 1200 are aligned however this assembly can be patterned to include a number of collimators 1200 placed side by side in a DWDM device.

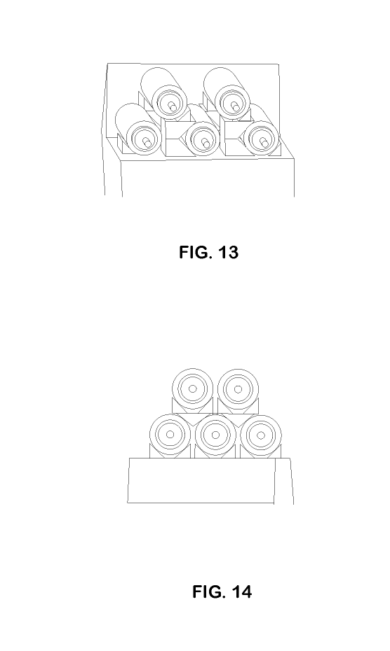

FIG. 13 and FIG. 14 are illustrations of multiple collimators positioned on top of a horizontal glass surface. In FIG. 13, the orientation is three collimators mounted under two collimators with triangular glass blocks. As described in FIG. 12, the triangular glass blocks allow the collimators a secure wedge-mounting position. There is a loose alignment of collimators as the spacing between each component is separated by glass triangular blocks. However, in FIG. 14, the tightly aligned structure of collimators shows the triangular blocks tightly positioned with three collimators on a bottom row and two collimators bridged to the bottom collimators with triangular glass blocks. In this illustration, the tightly packed collimator optical components are oriented to fit inside a compact DWDM device.

Although one or more embodiments of the newly improved invention have been described in detail, one of ordinary skill in the art will appreciate the modifications to the DWDM assembly including the glass substrate optical member to shorten the length of the optical device. It is acknowledged that obvious modifications will ensue to a person skilled in the art. The claims which follow will set out the full scope of the claims.

1. An optical assembly having an optical multiplexing mode and an optical demultiplexing mode, comprising:
an optical base;
a first optical transceiver set and a second optical transceiver set disposed on the optical base for transceiving a light beam;
wherein the optical base accepts the light beam from the first optical transceiver set, the light beam undergoes reflections and then scatters/converges in the optical base, the light beam then exits the optical base and move toward the second optical transceiver.

2. The optical assembly of claim 1, wherein
for the multiplexing mode, the first optical transceiver set outputs a plurality of light beams each with different wavelengths, the light beams enters the optical base and undergo reflections, the light beams then exits the optical base and travel toward the second optical transceiver set alone a common path, and for the demultiplexing mode, the first optical transceiver set outputs the light beam to enter the optical base and undergo reflections, the light beam scatters into a plurality of light beams each with different wavelengths that exits the optical base and travel toward the second optical transceiver set.

3. The optical assembly of claim 1, wherein the optical base includes:
an optical plate, wherein the first optical transceiver set and the second optical transceiver set are disposed on the optical plate; and
an optical prism disposed on the optical plate for accept at least one light beam from the first optical transceiver set, the light beam undergoes reflections in the optical prism and enter the optical plate, the light beam then undergo reflections and then scatter or converge in the optical plate, the light beam returns to the optical prism to undergo reflections and then exit the optical prism, the light beam then move toward the second optical transceiver set.

4. The optical assembly of claim 1, wherein the optical base includes:
an optical plate, wherein the first optical transceiver set and the second optical transceiver set are disposed on the optical plate;
a first prism disposed on the optical plate and near the first optical transceiver set for receiving the light beam from the first optical transceiver set, wherein the light beam undergoes reflections in the first prism and enters the optical plate to undergo further reflections; and
a second prism disposed on the optical plate for receiving the light beam from the optical plate and near the second optical transceiver set, the light beam then exiting the second prism and traveling toward the second optical transceiver set.

5. The optical assembly of claim 1, further comprising:
an anti-reflection layer disposed on the optical base for accepting the light beam from the first optical transceiver set or the second optical transceiver set; and
an optical filter disposed between the anti-reflection layer and first optical transceiver and between the anti-reflection layer and second optical transceiver, wherein the light beam travels from the anti-reflection layer toward the optical filter or from the optical filter toward the anti-reflection layer.

6. The optical assembly of claim 1, further comprising:
a reflection element disposed on a surface of the optical base for reflecting the light beam exiting the optical base back to the optical base.

7. The optical assembly of claim 6, wherein the reflection element includes a reflection coating and a reflection mirror.

8. The optical assembly of claim 1, wherein the first optical transceiver and the second optical transceiver are stacked one above another.

9. The optical assembly of claim 1, wherein the first optical transceiver set and the second optical transceiver set are arranged to be substantially in parallel.

10. A method to manufacture an optical assembly for performing an optical multiplexing mode and an optical demultiplexing mode, comprising steps of:
disposing a first optical transceiver set and a second optical transceiver set on an optical base and for transceiving a light beam;
using the first optical transceiver set to emit the light beam toward the optical base, wherein the light beam undergoes reflections and then scatter/converge in the optical base, the light beam then exits the optical base and moves toward the second optical transceiver.

11. The method of claim 10, further comprising:
executing the multiplexing mode, wherein the first optical transceiver set outputs a plurality of light beams each with different wavelengths, the light beams enters the optical base and undergo reflections, the light beams then exits the optical base and travel toward the second optical transceiver set alone a common path, and
executing the demultiplexing mode, wherein the first optical transceiver set outputs a light beam to enter the optical base and undergo reflections, the light beam scatters into a plurality of light beams each with different wavelengths that exit the optical base and travel toward the second optical transceiver set.

12. The method of claim 10, further comprising:
disposing an optical prism on an optical plate to form the optical base;
disposing the first optical transceiver set and the second optical transceiver set on the optical plate; and
using the first optical transceiver set to emit at least one light beam toward the optical prism, wherein the light beam undergoes reflections in the optical prism and enter the optical plate, the light beam then undergo reflections and then scatter or converge in the optical plate, the light beam returns to the optical prism to undergo further reflections and exit the optical prism, the light beam then move toward the second optical transceiver.

13. The method of claim 10, further comprising:
disposing a first prism and a second prism on an optical plate to form the optical base;
disposing the first optical transceiver set and the second optical transceiver set on the optical plate;
using the first optical transceiver set to emit at least one light beam toward the first prism, wherein the light beam undergoes reflections in the first prism and enters the optical plate to undergo further reflections; and
using the second prism to receive the light beam from the optical plate, wherein the light beam undergoes reflections in the second prism, the light beam then exits the second prism and travels toward the second optical transceiver set.

14. The method of claim 10, further comprising:
disposing an anti-reflection layer on the optical base;
disposing an optical filter between the anti-reflection layer and first optical transceiver and between the anti-reflection layer and second optical transceiver using the anti-reflection layer and the optical filter to accept the light beam, wherein the light beam travels from the anti-reflection toward the optical filter or from thee optical filter toward the anti-reflection layer.

15. The method of claim 10, further comprising disposing a reflection element on a surface of the optical base for reflecting the light beam exiting the optical base back to the optical base.

16. The method of claim 15, wherein the step of disposing the reflection element includes selecting a reflection coating and a reflection mirror as the reflection element to be disposed on the optical base.

17. The method of claim 10, further comprising stacking the first optical transceiver and the second optical transceiver one above another.

18. The method of claim 10, further comprising arranging the first optical transceiver set and the second optical transceiver set to be substantially parallel.

19. A device for demultiplexing a light beam or multiplexing light beams, comprising:
an optical base;
a first optical transceiver set for emitting at least one light beam toward the optical base; and
a second optical transceiver set;
wherein for the multiplexing mode, the first optical transceiver set outputs a plurality of light beams each with different wavelengths, the light beams enters the optical base and undergo reflections, the light beams then exits the optical base and travel toward a second optical transceiver set alone a common path, and
for the demultiplexing mode, the first optical transceiver set outputs a light beam to enter the optical base and undergo reflections, the light beam scatters into a plurality of light beams each with different wavelengths that exit the optical base and travel toward the second optical transceiver set.

20. The device of claim 19, wherein the reflection unit includes a reflection plate and a reflection prism set disposed on the reflection plate, the reflection prism set accepts at least one light beam from the first optical transceiver set, the light beam undergoes reflections in the reflection prism set and enter the reflection plate, the light beam then undergo reflections and then scatter or converge in the reflection plate, the light beam returns to the reflection prism set to undergo reflections and then exit the reflection prism set and move toward the second optical transceiver set.
